(19) United States
(12) Patent Application Publication
(10) Pub. No.: US 2009/0074221 A1
(43) Pub. Date: Mar. 19, 2009

(54) HOUSING FOR A HEARING AID, HEARING AID, AND A METHOD OF PREPARING A HEARING AID

(76) Inventor: Soren Erik Westermann, Humlebak (DK)

Correspondence Address: SUGHRUE MION, PLLC, 2100 PENNSYLVANIA AVENUE, N.W., SUITE 800, WASHINGTON, DC, 20037, US

(21) Appl. No.: 12/277,272

(22) Filed: Nov. 24, 2008

Related U.S. Application Data
(63) Continuation-in-part of application No. PCT/DK2006/000357, filed on Jun. 20, 2006.

(51) Int. Cl. H04R 25/00

(52) U.S. Cl. 381/327

(57) ABSTRACT

A custom-made BTE hearing aid housing (17) comprises a first part, and a second part, wherein said first part is adapted to fit the contour of the cleft between a pinna and the skull of an individual is provided. The housing may be part of a hearing aid (30), connected with a tube (9) in a first end and an earplug (20) in a second end. The invention also provides a hearing aid and a method of preparing a hearing aid housing.

### RELATED APPLICATIONS

The present application is a continuation-in-part of application no. PCT/DK2006/000357, filed on Jun. 20, 2006 and published as WO-A1-2007147406, the contents of which are incorporated herein by reference.

### BACKGROUND OF THE INVENTION

1. Field of the Invention

The present invention relates generally to hearing aids and to methods of manufacturing hearing aids. The invention, more specifically relates to Behind-The-Ear (BTE) hearing aids and methods of preparing them. The invention, still more particularly, relates to custom-made BTE hearing aids.

2. Description of the Related Art

Behind-the-ear (BTE) hearing aids is a subgroup within the general group of hearing aids worn by the ear. Hearing aid supported entirely by the ear are normally divided into three classes: Behind-The-Ear (BTE) hearing aids; In-The-Ear (ITE) hearing aids and Completely-In-the-Canal (CIC) hearing aids. A BTE hearing aid is the largest type and basically incorporates a housing or a shell that is adapted for being placed partially above and partially behind the users outer ear (the pinna). The housing provides a platform and encapsulation for electronic and acoustic components, such as a battery, a microphone, and an amplifier. In some types, the housing also contains a miniature loudspeaker, in the hearing aid parlance usually referred to as a receiver, that connects to a tube for conveying the receiver output into the ear canal of the user. The tube ends in an earpiece that couples with the ear canal. The earpiece may comprise a soft standard plug or it may comprise a customized plug. In use the housing is placed behind the external ear, partially concealed. In some BTE's the housing extends into a hook that serves the purpose of resting the hearing aid housing.

U.S. Pat. No. 6,228,020 shows a hearing aid with a faceplate and a shell customized to fit in the user's ear canal.

U.S. Pat. No. 5,487,012 discloses a method for manufacturing of a hearing aid housing, including a shell, which is individually matched to the shape of the auditory canal of a user. The method comprises the steps of a) direct or indirect acquisition of the shape of the auditory canal to obtain digital data representing the shape, b) conversion of the digital representation of the shape into a multi-dimensional computer model of the outer shape of the matching shell, and c) computer controlled production of the shell based on the data obtained from the three-dimensional computer model of the shell.

U.S. Pat. No. 6,879,697 shows a hearing aid with a face plate that is individually matched to the shape of the auditory canal of a user. Manufacture of the face plate includes a processing step based on data from a CAD/CAM model of the hearing aid housing, and utilizes a rapid prototyping technique.

WO-98/47319 shows a hearing aid for arrangement in a user's ear canal and including a shell customized to the users ear canal, components and a faceplate.

BTE hearing aids offer space for large batteries, larger amplifiers, telecoils, dual microphones, push buttons and switches to change between various functions etc. Such features are difficult or impossible to implement in smaller types. BTE hearing aids also permit the arrangement of a microphone and a receiver with a mutual spacing that better permits controlling acoustic feedback from the receiver to the microphone. Some users may find BTE hearing aids more comfortable in wearing. Thus, many users find good reasons to prefer BTE hearing aids rather than ITE or CIC hearing aids.

The state of the art BTE hearing aid comprises a standard housing that is curved to suit the general contour of the cleft between a pinna (left or right) and the skull of a user. The top part of the housing normally extends into a projecting hook that incorporates a sound conduit and provides a grip around the top part of the cleft between pinna and skull. As far as known to the inventor, within the context of commercial BTE hearing aids, customization has only been extended to the preparation of the earpiece, never to the housing.

### SUMMARY OF THE INVENTION

It is a feature of the invention to provide a housing for a hearing aid that is comfortable in use.

It is a further feature of the invention to provide a hearing aid that is simple in manufacture.

It is a still further feature to provide a hearing aid with excellent and comfortable retention on the user.

The invention, in a first aspect provides a hearing aid, comprising an ear piece, an acoustic output transducer, and a custom housing, the custom housing including a battery compartment, an outlet, an amplifier assembly, a microphone and a shell, the shell having a first part customized to fit the contour of the cleft between a pinna and the scull of an individual, a second part, and a projection, wherein said first part and said second part are manufactured integrally by a rapid prototyping process, and wherein said projection is shaped as a hook and accommodates an outlet.

Within the context of this disclosure the expression a customized structure signifies structure that has been adapted to an individual.

The hearing aid housing according to the invention includes a part that is customized to fit the contour of the cleft between a pinna and the skull of an individual. As this part will normally rest against corresponding parts of the cleft, customization provides for a housing that is superior in fit and comfort. The housing includes a second part that generally completes the housing but that is not necessarily adapted to rest in direct contact with the cleft of the user.

The two parts may be manufactured integrally or they may be manufactured as separate items and joined together by conventional means.

According to embodiments, the housing may comprise an outlet arranged in the second part. The outlet may be an opening for an acoustic output that can be conveyed by a tube to an earplug inserted in the users ear canal, or it may be an electric lead or a connector for an electric output, that is fed to a receiver arranged spaced from the housing, e.g. in an earpiece, and close to the users ear canal. Keeping the outlet away from the part of the housing intended to rest against the users ear canal avoids compromising the fit.

According to an embodiment, the housing may be extended into a hook, and the hook may accommodate the outlet. The hook may be partially customized to the user or it may be a standard shape, suitably arranged on the housing.

According to an embodiment, the housing comprises a third part, that is adapted to fit a part of an arm of a spectacle frame. This provides a superior fit of the hearing aid for a user who wishes to wear spectacles and hearing aids at the same time.

According to an embodiment, the housing defines an entrance opening for a battery compartment. The entrance opening is preferably arranged in that part of the housing that is not adapted to contact the user directly.

The invention, in a second aspect, provides a method of preparing a hearing aid for an individual, said method comprising the steps of establishing a representation of the contour of a part of the cleft between the scull and a pinna of said user, entering the representation into a computer and forming a computer model of the representation, forming a computer model of a hearing aid housing, the computer model housing having a first part customized to fit the contour of the cleft between a pinna and the scull of an individual, and a second part, selecting components including at least one microphone, and an electronic amplifier assembly for the hearing aid, arranging the selected components in the computer model to form a computer model of the hearing aid housing as fitted with components, preparing a housing based on the computer model of the housing by a rapid prototyping method, and assembling the hearing aid, mounting at least one of the electronic components through an entrance opening in the housing.

This provides a hearing aid that has a very comfortable fit. The housing may be prepared to a minimal size, just sufficient to accommodate components as selected by the individual user, thereby less conspicuous.

The invention, in a third aspect, provides a custom housing for a BTE hearing aid, said housing comprising a battery compartment, an outlet, an amplifier assembly, a microphone and a shell, the shell having a first part customized to fit the contour of the cleft between a pinna and the scull of an individual, a second part, and a projection, wherein said first part and said second part are manufactured integrally by a rapid prototyping process, and wherein said projection is shaped as a hook and accommodates an outlet.

According to an embodiment, the tube, or at least a part of it, is semi-rigid or resilient in order that the tube may also serve the purpose of resting the hearing aid on the external ear of the user. The earpiece is adapted, e.g. through resilience or customization to the users ear, to rest in the meatus of the ear canal.

According to an embodiment, the hearing aid comprises an earplug for contacting the meatus of the users ear canal, a contact element for resting against an inside of the users tragus, and a plug fixture for holding the earplug and the contact element together, the plug fixture having means for adjusting the spacing between the plug and the contact element. This type of plug provides a comfortable, partial support for the earpiece and is adapted to direct sounds amplified by the hearing aid towards the users ear canal. The support is complemented by the contact element, which rests against another part of the ear. The plug fixture permits adjusting the spacing between the plug and the contact element and thereby permits adapting the hearing aid to different sizes of ears, or to different preferences regarding pretension. The adjustment facility permits customizing the earplug in order that it may accommodate a wide variety of users.

Further embodiments will appear from the dependent claims.

Further features, embodiments and advantages will appear from the detailed part of the specification.

### BRIEF DESCRIPTION OF THE DRAWINGS

The invention will now be described in more detail with reference to the accompanying drawings, where

FIG. 1 illustrates a first step in preparation of a housing;

FIG. 2 illustrates a hearing aid with a housing arranged in a low position behind the ear;

FIG. 3 illustrates a hearing aid with a housing arranged in a medium position behind the ear;

FIG. 4 illustrates a hearing aid with a housing arranged in a high position behind the ear;

FIG. 5 illustrates a BTE hearing aid with a hook;

FIG. 6 illustrates a shell for a BTE hearing aid and a faceplate;

FIG. 7 illustrates a BTE hearing aid housing wherein a shell is joined with a faceplate;

FIG. 8 illustrates a section in a BTE hearing aid housing wherein the faceplate is integrated in the shell;

FIG. 9 illustrates a section in a BTE hearing aid housing wherein a shell is integrated with the faceplate and with a microphone entrance;

FIG. 10 illustrates a BTE hearing aid housing;

FIG. 11 illustrates a BTE hearing aid;

FIG. 12 illustrates a BTE hearing aid arranged adjacent a pair of spectacles;

FIG. 13 illustrates a BTE hearing aid according to another embodiment, arranged adjacent a pair of spectacles;

FIG. 14 illustrates a close-up of a housing with an indentation for spectacles;

FIG. 15 depicts a section in a hearing aid according to FIG. 12 as placed in the cleft between the scull and pinna; and

FIG. 16 illustrates a BTE hearing aid housing with a custom earplug.

### DETAILED DESCRIPTION OF THE INVENTION

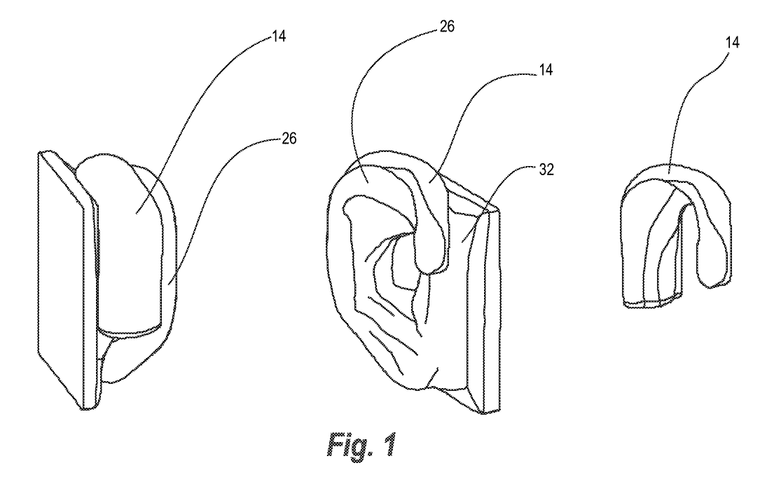

Reference is first made to FIG. 1 for an explanation of a first step in preparing a customized housing. The first step comprises providing a cast impression 14 of the users ear in the region behind the ear, i.e. in the cleft between the scull 32 and pinna 26, as illustrated in FIG. 1. During casting it is important not to strain or deform pinna in order that the impression will match the actual space of the cleft behind the ear while the ear and the pinna are relaxed. If the hearing aid user normally wears spectacles, an impression of part of a temple bar of a spectacle frame can be included in the cast impression 14.

The cast impression includes a surface portion directly cast by contact with the user and another surface portion that completes the impression and that has not been in direct contact with the user.

The second step in the preparation is to establish a computer representation of the impression. This can be done by optical scanning. More details about one method of digitization is explained in U.S. Pat. No. 5,487,012.

The third step is to form a computer model of the shell. The shell must have a finite thickness. A first part of the shell should match the contours of the users head and pinna. A second part of the shell should generally close the aperture left by the first part so as to create a generally closed housing. In the second part, details such as a microphone port, a battery door and a connection for a sound outlet must be accommodated. Interior components must be selected. In an interactive process, the fitter will play with a computer model, possibly testing different positions on the pinna, trying to position the components and orient them inside the shell, and to draw a nice cover on the shell. The process may include designing interior fixtures for various components. During this process he will be aided by computer visualizations of the completed hearing aid.

The fourth step is the manufacturing of the housing by means of a rapid prototyping method, e.g. using an SLA or an SLS equipment.

The fifth step is the mounting of components inside the housing and the making of the connections between the components.

The earplug may be an instant fit plug as described in WO2006/026988.

In a variant the earplug may also be manufactured by a rapid prototyping method. Suitable manufacturing methods are described in U.S. Pat. No. 5,487,012 and in a patent application DK PA200501017 filed in Denmark on 8 Jul. 2005, counterpart of US2008015287).

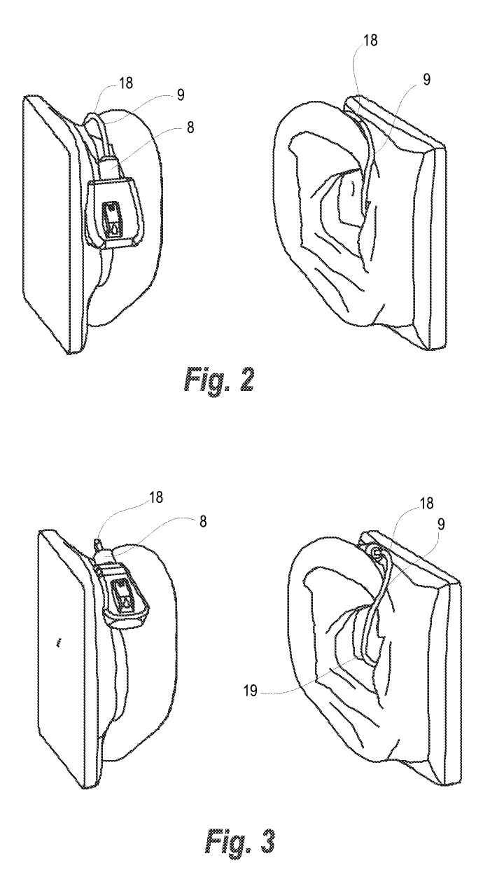

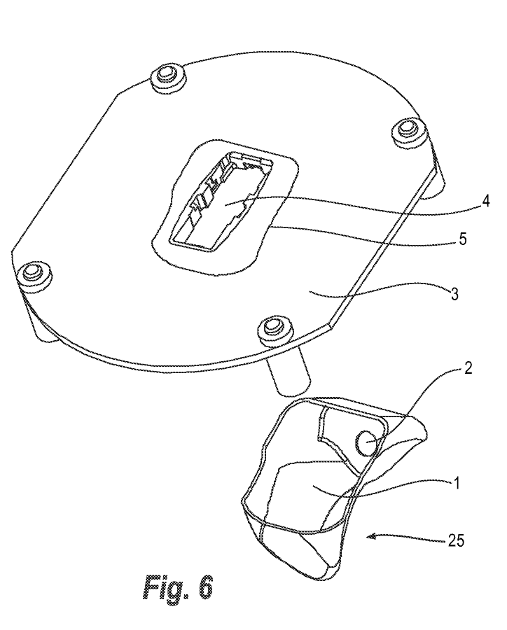

During the third step, the user together with fitter may be offered a range of options concerning exterior as well as interior details of the hearing aid. Some examples of exterior options will appear from the FIGS. 2-5 and 11-16, whereas some of the options concerning interior details will appear from the FIGS. 6-10.

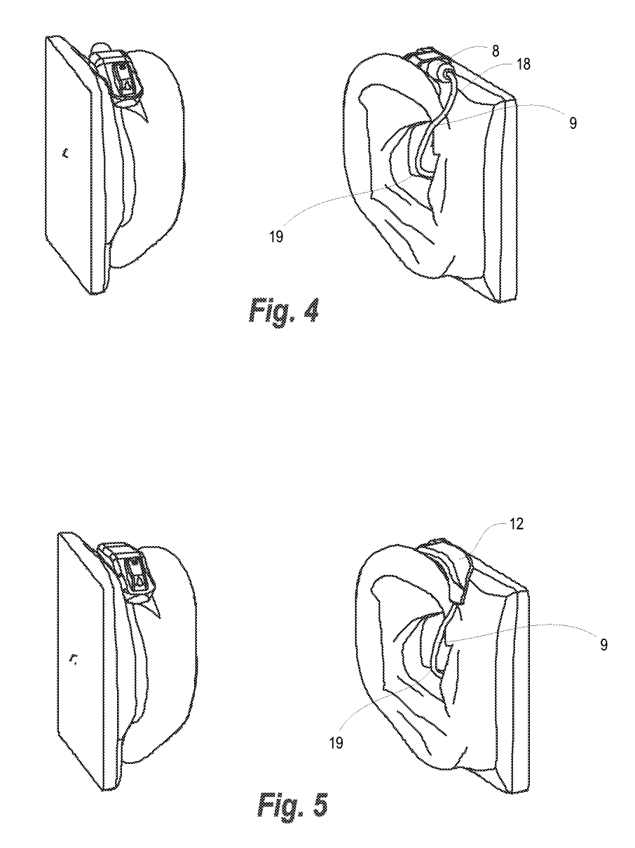

Specifically FIG. 2 illustrates a hearing aid with a housing arranged in a low position behind the ear. FIG. 3 illustrates a hearing aid with a housing arranged in a medium position behind the ear. FIG. 4 illustrates a hearing aid with a housing arranged in a high position behind the ear; and FIG. 5 shows a BTE hearing aid with a hook.

The size of housing and thus the shell is selected with a view to the electronics to be mounted inside. If e.g. the hearing aid is to be used for mild to moderate hearing losses, electronic components corresponding to those available for Completely-In-the-Canal, CIC, hearing aids can be used. For more profound hearing deficiencies components corresponding to those normally used for BTE hearing aids will be preferred. Open plugs may be favored for mild hearing deficiencies whereas closed, and in particular customized, plugs may be favored for more severe hearing losses.

In FIGS. 2-4 the housing is connected with a connecting element 8 on a tube 9, the tube 9 having a first bend 18 around the top of the pinna of the users ear directing it into the concha of the ear and a second bend 19 to direct an end of the tube into the ear canal of the user. The tube is resilient and assists to keep the housing in a fixed position behind the ear with the earplug 20 (FIG. 11) in a fixed position in the ear canal.

FIG. 5 shows a custom made BTE hearing aid wherein the forward part of the housing is formed as a hook 12 around the top of the ear and a tube 9 is fitted through the outlet opening of the housing.

FIG. 6 shows a shell 25 for a BTE hearing aid with a corresponding faceplate 3. The shell 25 has an aperture 1 and an outlet opening 2. The faceplate 3 has a prefabricated entrance opening 4 for mounting a battery compartment, and the dotted line 5 indicates the final contour of the faceplate 3 when mounted onto the shell 25. The faceplate 3 may e.g. be mounted by gluing the faceplate 3 and the shell 25 together. After gluing, the faceplate is trimmed by cutting away the parts protruding beyond the shell aperture. The electronic components are mounted in the shell through the entrance opening after trimming, e.g. as described in WO 98/47319.

The electronic components, e.g. microphone, signal processor and receiver, may be mounted through the battery opening. A sound tube may be connected by one end to a receiver while the other end is pulled through a sound outlet in the housing and connected to an earplug. Alternatively, if e.g. the hearing aid is to be used for profound hearing losses, the BTE housing may be connected by an electrical wire to a receiver in an earplug, thereby permitting a higher sound output without causing feedback. Another design option for adapting the hearing aid for a high sound output is by creating a larger housing 17 and arranging the microphone and the receiver with a mutual spacing so as to decouple feedback inside the housing.

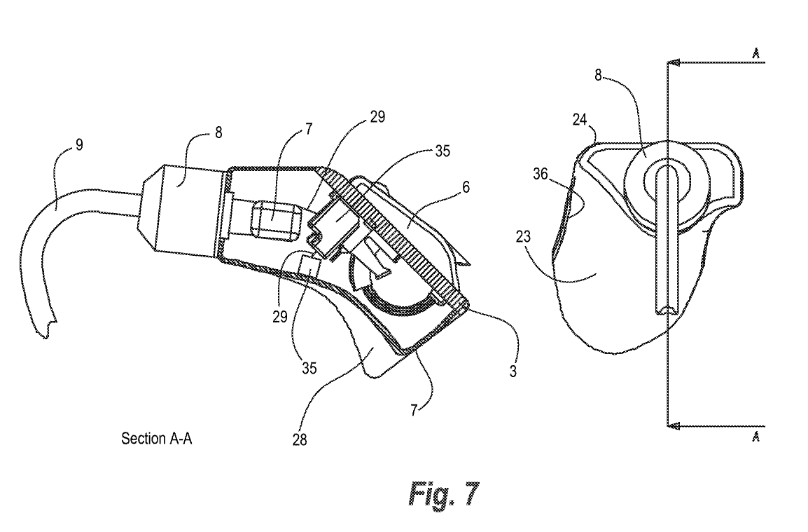

FIG. 7 shows the shell 25 joined with the faceplate 3 to finish the housing 17, a battery door 6 in the faceplate, and the electronic components, such as a microphone, a receiver 7, a signal processor and a telecoil 37 connected by interior wires. The shell 25 is connected to a tube 9 via a connecting element 8.

The shell comprises a first part 23 that matches a surface of the user and a second part 24, distinguished from the first part by demarcation line 36, that completes the shell. The second part generally includes a faceplate and a transition area connecting the faceplate to the first part. Thus, the first part is fully customized to the user, the second part is customized to match the first part along a selected contour, and the faceplate may be a standard shape.

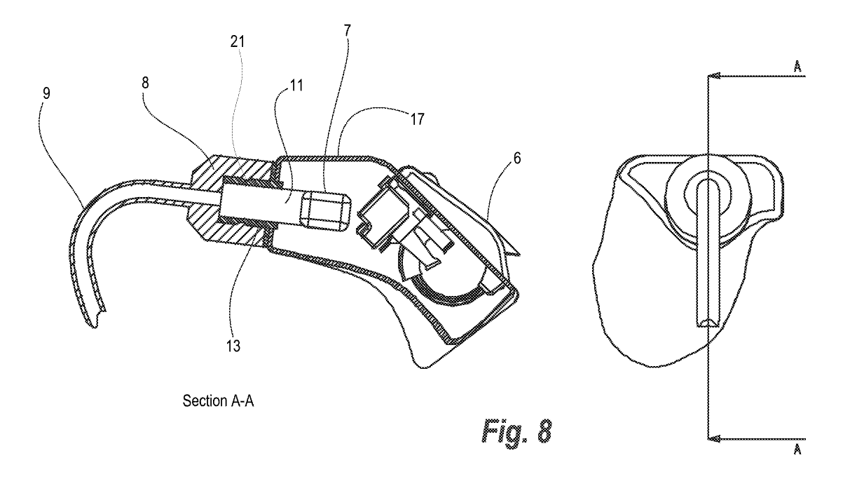

FIG. 8 shows a BTE hearing aid wherein the faceplate is integrated in the shell 25 to form the housing 17. All of the electronic components are mounted through a hole in the housing 17 corresponding to the entrance opening 4 in FIG. 6. The opening is closed by a battery door 6.

FIG. 8 shows a housing 17 joined with a connecting element 8 and a tube 9 via a bushing 13. The connecting element 8 has a lip 21 for engaging an annular groove of the bushing 13. Alternatively the connecting element 8 may be connected directly to the housing 17 e.g. by gluing the connecting element 8 to the housing 17. In another embodiment the bushing 13 is integrated in the housing 17.

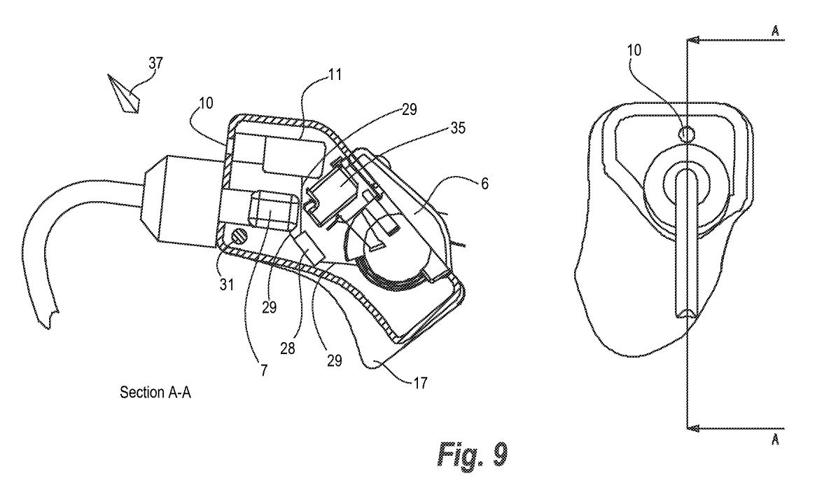

FIG. 9 shows another embodiment of the invention wherein the shell is integrated with the faceplate and has a microphone entrance port 10 leading to the microphone 11, which is mounted inside the housing 17. All of the electronic components 35 are mounted through an opening in the housing 17 corresponding to the entrance opening 4 in FIG. 6. FIG. 9 further shows a telecoil 28 and an antenna 31 for communicating with a remote control. When in position on the ear of the user, the hearing aid housing will assume a slanted orientation, as indicated by arrow 37 illustrating the vertical direction.

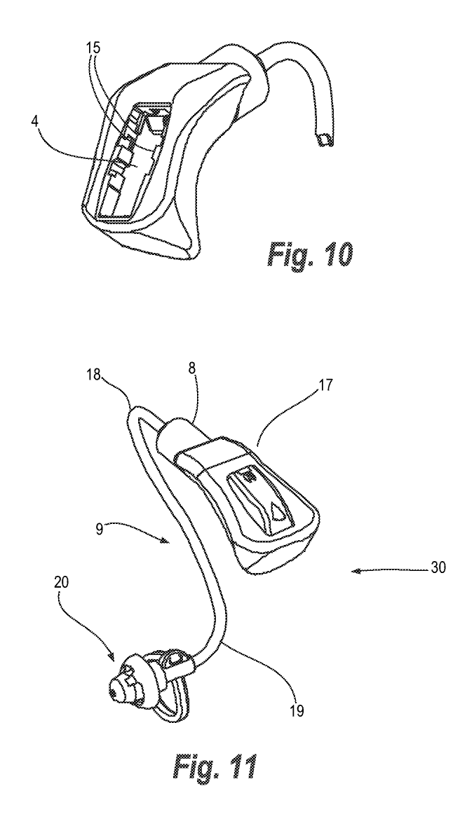

FIG. 10 shows a housing 17 before the electronic components are mounted through the entrance opening 4. The housing entrance opening 4 is delimited by an edge with engagement structure 15, and the opening provides an opening for a battery compartment. For further details reference may be had to WO 98/47319.

FIG. 11 shows a BTE hearing aid 30 comprising a hearing aid housing 17, a tube 9 with a first bend 18 and a second bend 19, a connecting element 8 and an earplug 20.

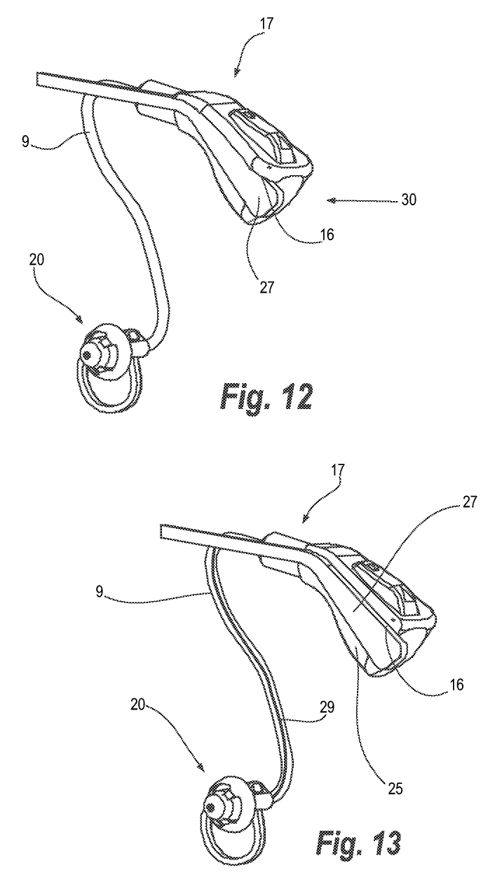

FIG. 12 shows a BTE hearing aid 30 comprising a hearing aid housing 17, a tube 9 and an open earplug 20. The hearing aid housing 17 is adapted by an indentation 16 to better fit a user wearing spectacles.

FIG. 13 shows a BTE hearing aid in an embodiment wherein the receiver is placed in the earplug 20 and connected to the other electrical components in the housing 17 by a wire 29 in the tube 9. The hearing aid 30 shown in FIG. 13 also comprises a housing 17 with an indentation 16 for an arm 27 of a pair of spectacles. By arranging the receiver in the earplug 20, a higher output can be achieved without feedback, especially if a closed earplug 20 is used.

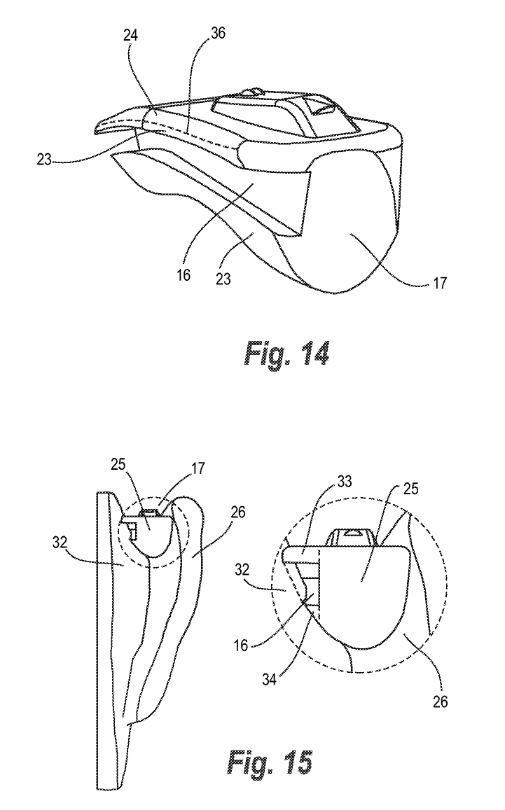

FIG. 14 shows a close-up of a housing 17 with an indentation 16 for spectacles. In this embodiment, the housing comprises a first part 23 customized to the pinna and the skull of the user, a part, i.e. the indentation 16, customized to a shape of the spectacles, and a part, generally designated the second part 24, that completes the housing.

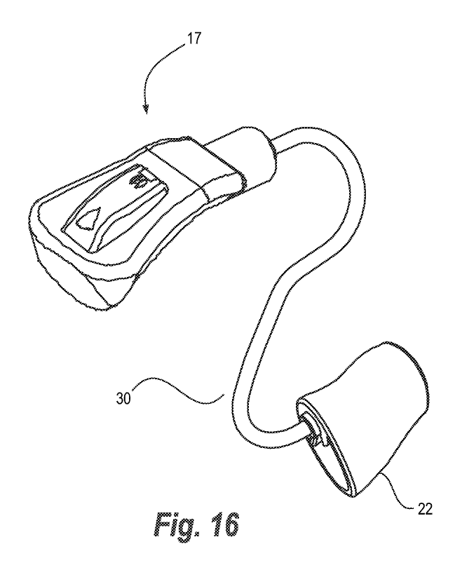

FIG. 15 depicts a section in a hearing aid 17 according to FIG. 12 as placed in the cleft between the scull 32 and pinna 26. In the enlarged picture a dotted line connects the first lobe 33 and the second lobe 34 of the shell, the dotted line indicating the contour of the scull. An indentation 16 defined by sides of the lobes and by an area between them and matching part of a temple bar of a pair of eyeglasses appears. In a modification, lobe 33 is removed leaving the indentation open upwards. In another variant, lobe 34 is removed, leaving the indentation open downwards. In yet another variant, both lobe 33 and lobe 34 are removed leaving just a bottom part of the indentation to contact the spectacle temple bar.

FIG. 16 depicts a hearing aid similar to the one in FIG. 11, but with the modification that it has a custom earplug 22. The custom earplug may be open or closed. This earplug is prepared by taking an impression of the users ear meatus, forming a computer model of the plug and using a rapid prototyping method. Further details about the custom earplug may be had in a patent application DK PA200501017 filed in Denmark on 8 Jul. 2005, (Published as WO2007006302 and US20080152871).

When designing the hearing aid housing, the fitter will use a computer in an interactive process, selecting various components, modeling the housing, trying different positions on the ear, trying different arrangements of the sound tube, testing various positions and orientations of components inside the hearing aid housing, and testing different angles of the top surface and the battery door etc. During this process, the computer will make visualizations to facilitate assessment by the fitter. The computer model will warn about constraints such as the scope of available space.

In case a telecoil is included, it is important that it has an accurate orientation in the position as used to properly pick up the magnetic signal. Normally it must have a vertical orientation within a deviation of not more than 30 degrees, preferably not more than 20 degrees from the vertical direction 37 (ref FIG. 9). In case of an antenna for communicating with a remote control or, in case of a binaural fit, an antenna for communicating with the other hearing aid, other constraints may prevail. These constraints will be programmed in the software.

During the design phase, the fitter will place the telecoil and the antenna for the remote control, while having the option of positioning these parts and of tilting them within the range allowed, so as to best utilize the space available inside the housing. Suitable fixtures for the telecoil and for the antenna, if selected, can be included in the model and can be manufactured by the rapid prototyping process.

I claim:

1. A hearing aid, comprising
an ear piece,
an acoustic output transducer, and
a custom housing, the custom housing including a battery compartment, an outlet, an amplifier assembly, a microphone and a shell, the shell having a first part customized to fit the contour of the cleft between a pinna and the scull of an individual, a second part, and a projection, wherein said first part and said second part are manufactured integrally by a rapid prototyping process, and wherein said projection is shaped as a hook and accommodates an outlet.

2. The hearing aid according to claim 1, comprising a third part, said third part being adapted to fit a part of an arm of a spectacle frame.

3. The hearing aid according to claim 1, wherein said second part comprises a battery door.

4. The hearing aid according to claim 1, wherein said second part comprises a microphone port associated with said microphone.

5. The hearing aid according to claim 1, wherein said housing includes a housing fixture for an interior component, said housing fixture being manufactured by a rapid prototyping process.

6. The hearing aid according to claim 5, wherein said housing fixture is adapted to hold a telecoil in an orientation selected with consideration to the orientation of the hearing aid as used.

7. The hearing aid according to claim 5, wherein said housing fixture is adapted to hold an acoustic output transducer.

8. The hearing aid according to claim 1, wherein said housing defines an entrance opening with engagement structure at an edge, said engagement structure being adapted for carrying said amplifier assembly.

9. The hearing aid according to claim 1, comprising an earplug for contacting the meatus of the users ear canal, a contact element for resting against an inside of the users tragus, and a plug fixture for holding the earplug and the contact element together, said plug fixture having means for adjusting the spacing between the earplug and the contact element.

10. A method of preparing hearing aid for an individual, said method comprising the steps of
establishing a representation of the contour of a part of the cleft between the scull and a pinna of said user,
entering the representation into a computer and forming a computer model of the representation,
forming a computer model of a hearing aid housing, the computer model housing having a first part customized to fit the contour of the cleft between a pinna and the scull of an individual, and a second part,
selecting components including at least one microphone, and an electronic amplifier assembly for the hearing aid,
arranging the selected components in the computer model to form a computer model of the hearing aid housing as fitted with components,
preparing a housing based on the computer model of the housing by a rapid prototyping method, and
assembling the hearing aid, mounting at least one of the electronic components through an entrance opening in the housing.

11. The method according to claim 10, wherein the step of arranging the selected components comprises defining position and orientation of the components.

12. The method according to claim 10, wherein the step of selecting components comprises selecting a telecoil, and wherein the step of arranging the components comprises deciding the orientation of the telecoil taking into account the orientation of the hearing aid as used.

13. The method according to claim 10, wherein the step of selecting components comprises selecting an antenna for a remote control, and wherein the step of arranging the components comprises deciding the orientation of the antenna taking into account the orientation of the hearing aid as used.

14. The method according to claim 10, wherein said step of establishing a representation comprises establishing a representation of a part of an armature of a spectacle frame, and said housing is created with a indentation adapted to fit a part of the armature of the spectacle frame.

15. A custom housing for a BTE hearing aid, said housing comprising a battery compartment, an outlet, an amplifier assembly, a microphone and a shell, the shell having a first part customized to fit the contour of the cleft between a pinna and the scull of an individual, a second part, and a projection, wherein said first part and said second part are manufactured integrally by a rapid prototyping process, and wherein said projection is shaped as a hook and accommodates an outlet.
